(19) United States
(12) Patent Application Publication
(10) Pub. No.: US 2015/0003626 A1
(43) Pub. Date: Jan. 1, 2015

(54) ACTIVE NOISE CANCELLATION METHOD FOR AUTOMOBILES

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/189,986

(22) Filed: Feb. 25, 2014

Related U.S. Application Data
(60) Provisional application No. 61/769,102, filed on Feb. 25, 2013.

(51) Int. Cl. H04R 3/00

(52) U.S. Cl. CPC H04R 3/002; H04R 2410/05
USPC 381/71.7

(57) ABSTRACT

A Noise Cancellation Process for enclosed cabins is disclosed. According to one embodiment, an input audio source corresponding to sound received from multiple microphones situated equidistantly in both directions in a two dimensional plane, is converted to a digital signal via an analog to digital (A/D) convertor. The A/D converted audio is analyzed for content to identify ambient noise. The frequency, amplitude and phase of the identified ambient noise is subsequently determined. A Noise correction sound wave is generated with negative phase of that corresponding to the identified ambient noise. The noise correction sound wave is added to the identified noise to create a noise corrected sound.

CROSS-REFERENCE TO RELATED PATENT APPLICATIONS

Embodiments of the present invention relate to U.S. Provisional Application Serial No. 61/769,102, filed Feb. 25, 2013, entitled “ACTIVE NOISE CANCELLATION IN A VEHICLE SUCH AS AN AUTOMOBILE”, the contents of which are incorporated by reference herein and which is a basis for a claim of priority.

### BACKGROUND OF THE INVENTION

The present invention relates to a method and device for enhancing an audio source by reducing and eliminating background and other ambient noise in the sound wave, especially suitable for automobiles.

Active noise control (ANC), also known as noise cancellation, or active noise reduction (ANR), is a method for reducing unwanted sound by the addition of a second sound specifically designed to cancel the first.

Sound is a pressure wave, which consists of a compression phase and a rarefaction phase. A noise-cancellation speaker emits a sound wave with the same amplitude but with inverted phase (also known as antiphase) to the original sound. The waves combine to form a new wave, in a process called interference, and effectively cancel each other out—an effect which is called phase cancellation.

Modern active noise control is generally achieved through the use of analog circuits or digital signal processing. Adaptive algorithms are designed to analyze the waveform of the background aural or nonaural noise, then based on the specific algorithm generate a signal that will either phase shift or invert the polarity of the original signal. This inverted signal (in antiphase) is then amplified and a transducer creates a sound wave directly proportional to the amplitude of the original waveform, creating destructive interference. This effectively reduces the volume of the perceivable noise.

FIG. 1 provides an example—A noise-cancellation speaker may be co-located with the sound source to be attenuated. In this case it must have the same audio power level as the source of the unwanted sound. Alternatively, the transducer emitting the cancellation signal may be located at the location where sound attenuation is wanted (e.g. the user's ear). This requires a much lower power level for cancellation but is effective only for a single user. Noise cancellation at other locations is more difficult as the three dimensional wavefronts of the unwanted sound and the cancellation signal could match and create alternating zones of constructive and destructive interference, reducing noise in some spots while doubling noise in others. In small enclosed spaces (e.g. the passenger compartment of a car) global noise reduction can be achieved via multiple speakers and feedback microphones.

These systems are typically a “static” type of system, meaning that someone or something has taken a reading of a particular enclosed area at a single moment in time. A system operating in this way is marginally effective, but still effective in some small way, and never removes the majority of offending noises as they continually change. There are many things that add to these changes such as the number of people in the space, which usually changes several times a day; the temperature and humidity have an affect on the acoustic properties of a space; any “new” type of noise added into the space; outside noise that gets into the space; and environmental noises from outside the space.

As can be seen there are many factors that are detrimental to the operation of a typical noise canceling system. Any single or multiple of these things can dramatically change the acoustic properties of a room as well.

Historically, automobile manufacturers have paid little attention to interior acoustics and environmental conditions in the passenger cabin. The “insulation” and sound dampening material originally installed in vehicles was marginally effective in its day and by now, has greatly deteriorated. Even in today's new cars, interior acoustics are a low priority unless you purchase a vehicle in the luxury car level¹. ¹http://www.quietride.com/auto-acoustics-101.htm

Typical complaints restorers and custom car builders encounter when it comes to sound and heat management include²: ²See, n.1, above.
Engine, transmission, drive shaft, tire and exhaust noise invade the floor.
Heat from the sun radiates into the passenger cabin.
Air conditioning system does not effectively reduce temperatures.
Noise from the trunk compartment and package shelf invades the passenger cabin.
Heat and noise comes through the firewall.

Noise invades an automobile passenger cabin through one of two paths³: “Whether your pride and joy is a Model A Ford, Tri-Five Chevrolet Coupe, a 2007 Mustang Fastback or a 1967 Firebird, most cars come from the factory with virtually no OE insulation,” said Timothy Cox, president of QuietRIDE Solutions in Stockton, Calif. “People love their cars and trucks, but the noise that resonates throughout the passenger cabin “simply wears the driver and passengers out on an extended trip.” Radiant heat is a closely related issue⁴. ³See, n.1, above.⁴See, n.1, above.

The physics of sound and vibration inside a vehicle isn't that hard to understand. The two main components of passenger cabin noise are “airborne noise” and “vehicle-structure noise” (vibration). Air-borne noise is generated from wheel vibration on the road surface, wind shear, engine mechanics, transmission harmonics or exhaust system harmonics that make their way through vehicle body panel joints in the passenger cabin. Sealing any gaps, installing damper strips and installing a thermal acoustic type automotive barrier, is much like adding a double pane window to your home, the interior of the vehicle gets quieter. Structure-borne noise is produced by direct vibration of unsupported, thin metal automotive body panels due to engine, transmission, or wheel movement. Both types of noise can be lessened with aftermarket sound-dampening materials⁵. It isn't until a consumer spends upwards of $60,000 to $80,000 on a high end luxury vehicle that they get the level of sound dampening that the aftermarket products can provide⁶. ⁵See, n.1, above.⁶See, n.1, above.

Cars and trucks absorb noise, vibration and heat (NVH) from multiple directions, which “Apex” in the passenger cabin at ear level⁷. ⁷See, n.1, above.
Engine NVH travels from the front of the vehicle through the firewall and cowl.
Transmission and drive line noise, wheel well and trunk panel NVH travels forward through the seat divider and package tray panels.
Performance exhaust systems produce noise and heat which penetrate the floor pans.
Direct heat from the sun penetrates the roof of the vehicle
Road way heat, which often exceeds 140 degrees, travels through the floor pans of the vehicle.

All of these influences meet in the middle of the vehicle where the passengers sit. A normal conversation builds into a “shouting match” between the driver and passengers to overcome the “harmonic drone” of the vehicle mechanics. “When you add the noise produced by the sound system, and the air rushing through the vents of the air conditioning system, the whole driving experience is less pleasure and contributes to driver fatigue” according to Timothy Cox, president of Quiet Ride Solutions. “Reducing the noise and heat inside the passenger cabin has as much to do with driver safety as it does with making the ride more comfortable, he said⁸. “A lot of cars come to us with passenger cabin decibel readings of 100 db and above. We can easily reduce those numbers by 12 to 17 dBs.” While that may not sound like much mathematically, sound reduction is based on an algorithmic scale. An easy way to understand that sort of sound is to think of 100 db as being the sound that a chop saw emits as it rips through a two by four. A reduction of only 10 dB is a 50 percent reduction in sound that the human ear can detect⁹. ⁸See, n.1, above.⁹See, n.1, above.

Today's motor vehicle manufacturers, in an effort to reduce vehicle weights in the name of fuel efficiency and price competitiveness, have eliminated most of what little insulation was once put into cars and trucks at the factory, according to Cox, “We have literally stripped more than 500 cars and trucks in the last ten years—vehicles that are now 50 years old, as well as new vehicles. What we have found is that manufactures no longer put any form of sound dampening or insulation in trunk panels, rear wheel wells. To speed the vehicle assembly process, manufacturers have combined their insulation materials with the finished interior panels. Insulation is glued to the back of carpets, door panels, plastic body panel covers and molded headliner covers. The rear seat cushion—if there is one—has become the barrier between the trunk cavern and the passenger cabin. Even the old-fashioned multi-layered firewall insulator panel, the first line of defense against engine noise and heat, has been reduced to a simple piece of “shoddy,” a jute-like material, glued to the firewall bulkhead panel¹⁰. ¹⁰See, n.1, above.

A new noise cancelation method and process is required that addresses the above noted deficiencies of the conventional noise reduction methods and systems.

### SUMMARY OF THE INVENTION

The Active Noise Cancellation (“ANC”) for Automobiles of the present invention is a system consisting of both analog and digital components that is specifically designed for reducing and eliminating ambient noise in an enclosed cabin environment of various sizes and shapes, such as those found in aircrafts, ships, trains, automobiles and even homes. The method and system is dynamic in that it continuously monitors and changes as the ambient noise in the cabin changes.

The inventive ANC for Automobiles system includes two or more microphones that are placed in the target cabin in which noise reduction is sought, preferably the microphones are situated in equal distances in the horizontal and perpendicular directions corresponding to a two-dimensional plane. Each microphone monitors sound waves in its corresponding zone and the overlaps of any of its surrounding zones. The number of microphones and zones will be determined by the size of the enclosed cabin the system is used in. Preferably, the microphones are of the Cardioids type.

The signals from the microphones are fed to an analog to digital converter, which converts the analog signals received from the microphones to digital signals. The converted digital audio is analyzed for content and ambient noise is identified for further processing. The ambient noise is monitored for changes. There could be a single or multiple noise frequencies that are identified and subsequently monitored.

Changes to the amplitude, frequency and phase of the ambient noise are subsequently performed as necessary. Phase Modulator dynamically changes the phase of the ambient noise, always in a negative amount, of the digital audio received. The negative phase sound is added back to the original noise which results in a reduction or cancellation of the sound wave corresponding to the noise. These changes are dynamic and self adjusting in nature. The modified, noise corrected digital sound output is changed back to an analog signal and fed into the audio playback system for noise reduction.

### BRIEF DESCRIPTION OF THE DRAWINGS

FIG. 1 is a block diagram depicting a conventional noise cancellation method.

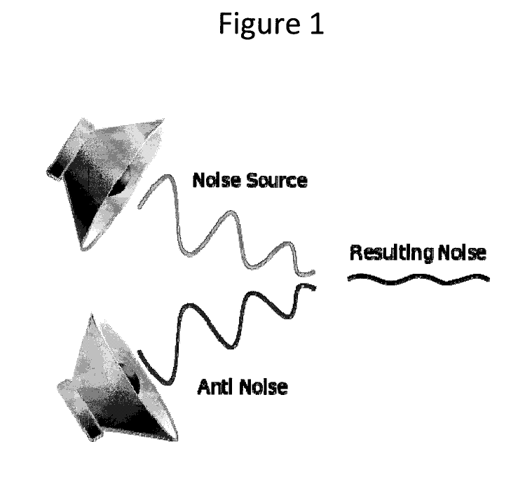

FIG. 2 Shows the polar pattern corresponding to a conventional Cardiod microphone.

FIG. 3 is a block diagram showing the operation of the present invention according to an exemplary embodiment.

FIG. 4 is a block diagram of an exemplary embodiment showing a system incorporating Active Noise Cancellation for Automobiles according to the present invention.

FIGS. 5(a) and 5(b) are exemplary illustrations of how the inventive process determines and differentiates noise from desirable audio.

### DETAILED DESCRIPTION OF THE PREFERRED EMBODIMENT(S)

The inventive Active Noise Cancellation for Automobiles monitors the target space, or zones continuously, or at pre programmed intervals, and self adjusts to compensate for any changes. If the noise lessens in that zone, it will turn itself down or even off if it detects no noise until the systems next check of the zones. Using cardioid microphones, it is possible to isolate a space into several zones with very little overlapping of those sections.

By way of background, the most common unidirectional microphone is a cardioid microphone, so named because the sensitivity pattern is a cardioid. The cardioid family of microphones is commonly used as vocal or speech microphones, since they are good at rejecting sounds from other directions. In three dimensions, the cardioid is shaped like an apple centered around the microphone which is the “stalk” of the apple. The cardioid response reduces pickup from the side and rear, helping to avoid feedback from the monitors. Since pressure gradient transducer microphones are directional, putting them very close to the sound source (at distances of a few centimeters) results in a bass boost. This is known as the proximity effect. The SM58 has been the most commonly used microphone for live vocals for more than 40 years demonstrating the importance and popularity of cardioid mikes.¹¹ ¹¹ http://en.wikipedia.org/wiki/Microphone

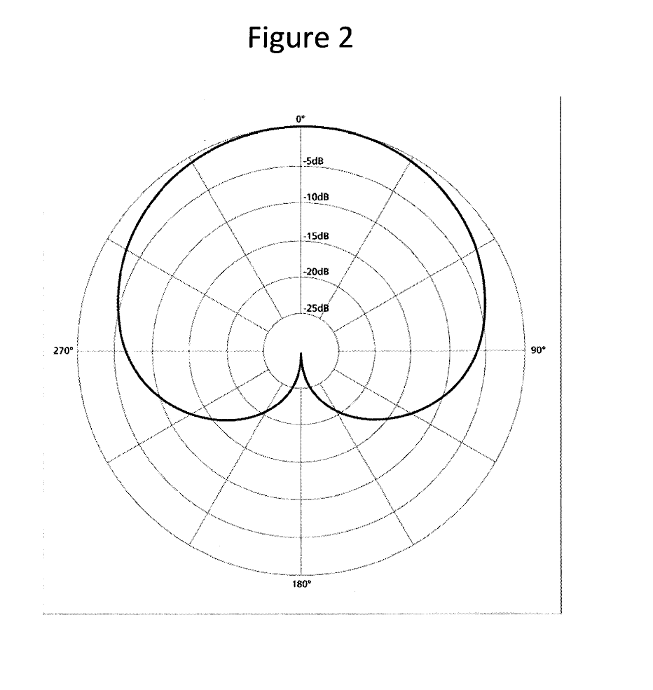

The polar pattern for a conventional cardioid phone is shown in FIG. 2. A cardioid microphone is effectively a superposition of an omnidirectional and a figure-8 microphone; for sound waves coming from the back, the negative signal from the figure-8 cancels the positive signal from the omnidirectional element, whereas for sound waves coming from the front, the two add to each other. A hypercardioid microphone is similar, but with a slightly larger figure-8 contribution leading to a tighter area of front sensitivity and a smaller lobe of rear sensitivity. A supercardioid microphone is similar to a hypercardioid, except there is more front pickup and less rear pickup. While any pattern between omni and FIG. 8 is possible by adjusting their mix, common definitions state that a hypercardioid is produced by combining them at a 3:1 ratio, while supercardioid is produced with a 5:3 ratio.

The Active Noise Cancellation for Automobiles is a system for decreasing ambient noise in an automobile. As pointed out above, this system is dynamic in that it is constantly monitoring and changing as the ambient noise in the automobile cabin (referred to as “cabin”) changes. The system consists of both analog and digital components. According to one embodiment, the microphones in the cabin are laid out in equal distances and monitor both its own zone and the overlaps of any zones around it. The number of microphones and zones will be determined by the size of the cabin the system is used in, four would be typical in an automobile. They are all converted to digital and fed into a computer that will analyze, compare, and change each zone as needed in real time. According to one embodiment, a single zone will have multiple filters with varying frequencies and widths.

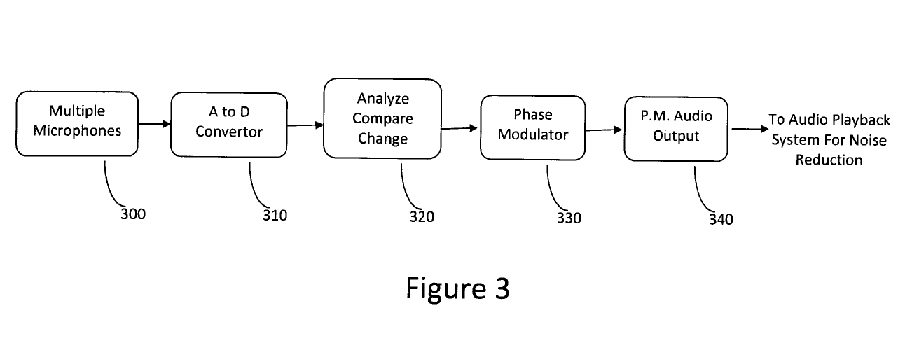

An embodiment of the operation of the Active Noise Cancellation (ANC) technique of the present invention is depicted in the block diagram of FIG. 3. Preferably, the inventive ANC process for Automobiles is performed by a single module identified by reference numeral 330 in the system shown in the block diagram of FIG. 3.

As shown in FIG. 3, multiple microphones 300 provide the input audio source received for further analysis and processing. Preferably, the microphones 300 are of the Cardioid type. According to one embodiment, the microphones 300 are placed in the corners of the cabin with their pattern center at a 45 degree from the corner position they are installed in. Preferably, the microphones 300 are spaced in the cabin in equal distances from each other.

The input audio from Multiple Microphones 300 is fed to an analog-to-digital (A/D) convertor 310, where the input audio analog signal is converted to a digital format.

The converted digital audio from the A/D convertor 310 is fed to the inventive Analyze/Compare/Change module 320 for processing. The Analyze/Compare/Change module 320 performs several steps on the sound wave it receives from the A/D converter 310 which will ultimately result in an audio sound with reduced or cancelled ambient noise levels.

In the Analyze step, A/D converted audio sound 310 is analyzed for content and ambient noise is identified. Once the noise wave is identified, it is further analyzed for frequency, amplitude and phase values. The Compare step monitors the amplitude, frequency and phase of the original sound wave for changes to ambient noise are subsequently performed as needed to identify any additions or changes to the determined noise. The Change step identifies any changes that are needed to be made to the incoming digital noise in both positive and negative direction, in the identified ambient noise.

Phase Modulator step 330 dynamically changes the phase of the identified ambient noise and creates a new noise correction wave based on the digital audio received. These changes are dynamic and self adjusting in nature.

Phase Modulator Audio Output step 340 is a phase modulated audio output (digital or analog) that feeds into the existing audio system in the enclosed cabin. In this step the modified noise output from the Phase Modulator 330 is added back to the original noise in a phase shift of 90 to 180 degrees as needed to cancel out the input noise. The resulting combination of the original noise sound waves and the newly created noise correction wave will result in a reduction and cancellation of the noise present in the original audio sound. This Phase Modulation is a constantly changing amount. The amount of change is derived from the analyzing of the input noise and its amplitude plus harmonic content.

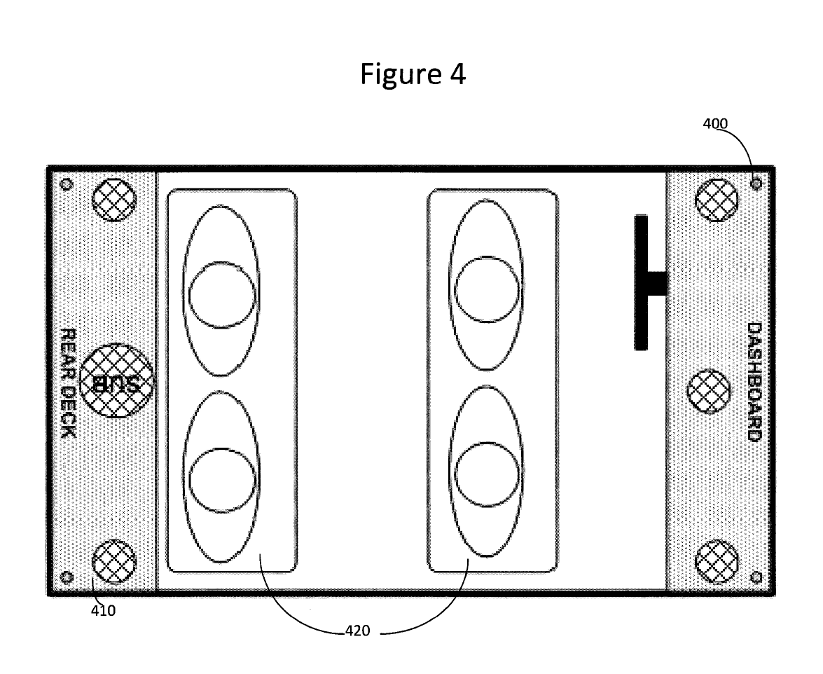

FIG. 4 shows a typical cabin setup for the Active Noise Cancellation for Automobiles system according to an embodiment of the present invention. Microphones 400 are placed in the corners and also identify the areas corresponding to the zones. Speakers 410 are located along the front and back of the automobile cabin. Passengers in the front and back rows are identified by reference numeral 420.

As the automobile's internal noise levels increase and decrease, as well as change frequencies, the system will continually “self adjust” to allow for these changes in it's operation. Any sudden noises, such as dropping something, will be ignored as they are too short in duration for the system to identify them as noise. Any continually repeating frequencies would be considered noise (engines, wind on the exterior of the automobile, etc.). The playback for the phase changed audio would be either a dedicated one or using the existing sound system of the automobile if necessary.

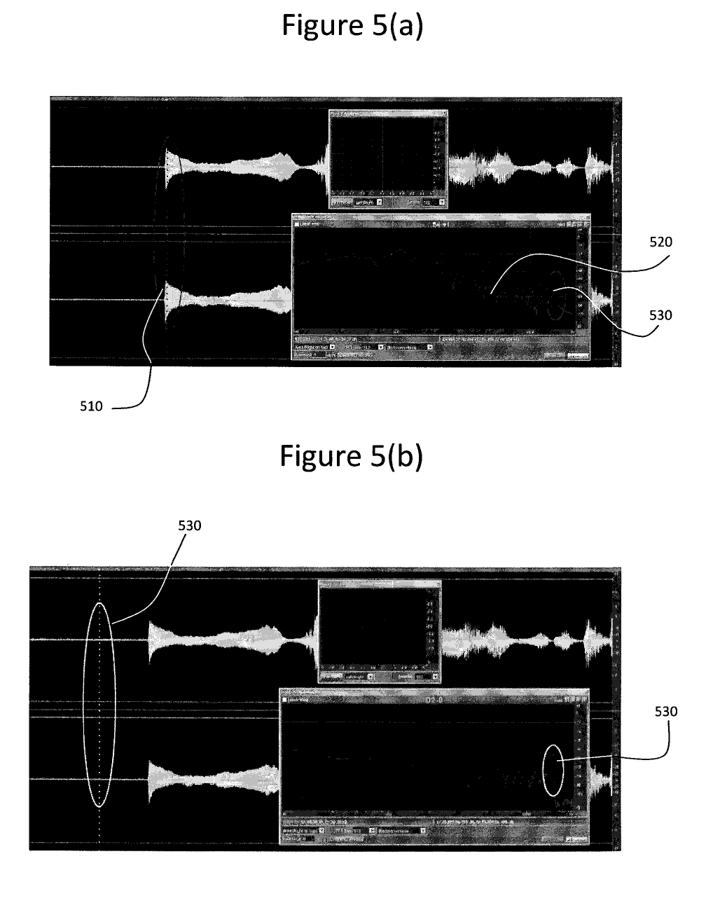

FIGS. 5(a) and 5(b) show an exemplary illustration of how the inventive process determines and differentiates noise from desirable audio. The Figures show examples of audio that includes a small amount of noise. 510 and 520 refer to the desired audio in this example. 530 identifies the audio noise in this example, which is also identified by the circles in FIG. 5(b). This particular noise is about 15.5 kHz with a narrow bandwidth, as most noise is. This spike will continue to appear through the audio clip thus identifying it as something that is constant and needs to be removed.

Although the present example discusses a single noise frequency, the invention is not limited in that way and there can be multiple noise frequencies that need to be removed. Once identified as “noise” the process will analyze for the frequency, amplitude, and phase. At this point, negative audio will be generated and summed with the original audio thus cancelling the offending “noise”. The original will continue to be monitoring the offending frequencies and if there is any change, the process will make the same change, but in a negative direction to make sure that the noise is effectively cancelled out. This will continue to dynamically monitor and generate audio until there is no input or it is bypassed. Accordingly, when the phase of the noise changes, so does the amount of negative phase audio.

What is claimed is:

1. A Noise Cancellation Process for an automobile cabin comprising:
Providing an input audio source from an enclosed cabin;
Converting the input audio source to a digital signal via an analog to digital (A/D) convertor;
Analyzing the A/D converted audio for content and identifying ambient noise;
Determining frequency, amplitude and phase of the identified ambient noise;
Generating a noise correction sound wave with negative phase of that corresponding to the identified ambient noise;
Summing the noise correction sound wave and the identified noise sound wave to create a noise corrected audio sound wave.
Outputting the noise corrected audio sound with diminished noise.

2. The Noise Cancellation Process of claim 1 wherein the negative phase is a phase shifted wave with a shift of between 90 and 180 degrees from the original phase amount.

3. The Noise Cancellation process of claim 1 further comprising monitoring the A/D converted audio for changes in the ambient noise and identifying any additional noise waves.

4. The Noise Cancellation Process of claim 1, wherein the input audio source is received from multiple microphones situated in the enclosed cabin.

5. The Noise Cancellation Process of claim 4, wherein the microphones are of Cardiod type.

6. The Noise Cancellation Process of claim 6, wherein the microphones are located at the four corners of the automobile.
